(19) United States
(12) Patent Application Publication
(10) Pub. No.: US 2002/0161160 A1
(43) Pub. Date: Oct. 31, 2002

(54) Preparation of organic polyisocyanates

(75) Inventors: Matthias Klotzer, Kroppen (DE); Volker Krase, Lauchhammer (DE); Konrad Morgenschweis, Dresden (DE); Peter Pfab, Schwarzheide (DE); Andreas Schmidt, Boxdorf (DE); Dieter Starosta, Schwarzheide (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: BASF Aktiengesellschaft, Ludwigshafen (DE)

(21) Appl. No.: 10/091,446

(22) Filed: Mar. 7, 2002

(30) Foreign Application Priority Data
Mar. 10, 2001 (DE) 10111645.4

(51) Int. Cl. C08G 18/00

(52) U.S. Cl. 528/44

(57) ABSTRACT

Organic polyisocyanates are prepared by a process in which polyurethanes are thermally dissociated in a dissociation reactor, a distillation is subsequently carried out and the bottom fraction obtained here is recirculated, wherein the recirculated bottom fraction is firstly fed at least partly into a reaction region and subsequently into the dissociation reactor.

The present invention relates to a process for preparing organic polyisocyanates by thermal dissociation of polyurethanes.

The phosgene-free processes known from the prior art for preparing organic polyisocyanates are based on the formation of monomeric polyurethanes from polyamines and carbonic acid derivatives and the subsequent thermal dissociation of the monomeric polyurethanes into alcohols and polyisocyanates.

It is known from EP 0 355 443 and 0 566 925 that the monomeric polyurethanes formed in the urethane formation step are usually firstly freed of alcohol and the low-boiling by-products such as carbamates and carbonates by distillation. High-boiling components are subsequently removed as a residual bottom fraction either by complete distillation of the entire urethane stream (EP 0 355 443) or by distillation of only part of the urethane stream (EP 0 566 925). According to EP 0 566 925, the dissociation of the monomeric polyurethanes is subsequently carried out continuously at from 200 to 300° C. and a pressure of from 1 to 200 mbar while distilling off the volatile dissociation products. The undissociated proportion of the reaction mixture and the high-boiling by-products formed constitute a bottom fraction which is recirculated to the urethane formation process.

The bottom fraction obtained in the subsequent final distillation of the polyisocyanate still contains relatively large amounts of only partially dissociated isocyanate containing urethane groups and oligomers derived therefrom. Such oligomers are, in particular, allophanates. This bottom fraction is discharged continuously and recirculated to the dissociation reactor.

These procedures have the disadvantage that the partially dissociated isocyanates containing urethane groups are volatile under the conditions prevailing in the dissociation reactor and accordingly vaporize immediately. A large part of the recirculated isocyanate containing urethane groups is accordingly not dissociated. Together with the partially dissociated isocyanate containing urethane groups from the lower column runback, this leads to an increase in the steady-state amount of this intermediate in the region below the side offtake of the rectification column. This in turn leads to more partially dissociated isocyanate containing urethane groups being taken off at the side offtake and in turn being recirculated after the subsequent isocyanate distillation as high boilers to the dissociation reactor. This finally leads to only an increased energy consumption in the dissociation reactor for this additional vaporization requirement without being able to achieve an efficient increase in the polyisocyanate yield.

It is an object of the present invention to provide a process for preparing organic polyisocyanates in which polyurethanes are thermally dissociated in a dissociation reactor, a distillation is subsequently carried out and the bottom fraction obtained here is recirculated and which does not have the disadvantages described. In particular, this process should provide a method by means of which the concentration of partially dissociated isocyanate containing urethane groups at the side offtake of the rectification column can be reduced while at the same time increasing the yield of the urethane dissociation process.

We have found that this object is achieved by the recirculated bottom fraction firstly being fed into a reaction region and subsequently into the dissociation reactor.

Additional monomeric polyurethane can be introduced into the reaction region. According to the present invention, it is possible either to feed all of the monomeric polyurethane into the reaction region or to feed only part of the monomeric polyurethane into the reaction region while introducing the other part directly into the dissociation reactor. The ratio of polyurethane fed directly into the dissociation reactor to polyurethane introduced into the reaction region depends on the respective process conditions. In particular, the amount of polyurethane added depends on the amount of recirculated bottom fraction, i.e., particularly when starting up the process, most of the polyurethane is initially introduced directly into the dissociation reactor. The recirculation of the partially dissociated isocyanate containing urethane groups can occur wholly or only partly from the bottoms from the final isocyanate distillation. In addition or as an alternative, recirculation can also be carried out wholly or partly from the lower runback of the rectification column to the dissociation reactor.

Both the monomeric polyurethane and the bottom fraction can, in a preferred embodiment of the invention, be recirculated continuously to the reaction region.

The use according to the present invention of the reaction region thus results in the recirculated bottom fraction which comprises only partially dissociated isocyanate containing urethane groups combining wholly or partly with the monomeric polyurethane fed to the dissociation. A chemical reaction of the monomeric polyurethane fed in with the isocyanates from the recirculated bottom fraction occurs in the reaction region. The result is partial or complete conversion into allophanates.

The allophanate-containing mixture formed from the monomeric polyurethanes and the partially dissociated isocyanates containing urethane groups from the recirculated bottom fraction in the reaction region preceding the dissociation is fed to the dissociation reactor for preparing the polyisocyanate. This process is preferably carried out continuously.

According to the present invention, the reaction region is preferably configured as a heatable vessel. It is particularly preferably configured as a separate vessel. In a preferred variant of the invention, this is configured as a reservoir which is located in the feed line to the dissociation reactor. The heated vessel is advantageously stirred continuously and/or circulated continuously by means of a pump to obtain good mixing. However, the reaction region can also be located in the return line to the rectification column. In addition, at least one separate feed line for monomeric polyurethane is provided.

In a further variant of the invention, the reaction region can be integrated into the rectification column located downstream of the dissociation reactor. For this purpose, preference is given to providing the rectification column with a suitable internal structure in which the formation of the allophanates occurs. The allophanate formation preferably occurs on a column tray having a defined volume and/or in a runback divider having an enlarged volume and/or in a separate residence reactor, in particular a reactor having a narrow residence time distribution. The allophanates are formed by reaction of compounds containing urethane groups and compounds containing isocyanate groups from the runback from the rectification column for separating off the dissociation products below the side offtake for polyisocyanate.

A further alternative is an additional recirculation of the bottom streams from the final polyisocyanate distillation into the residence sections of the rectification column located downstream of the dissociation reactor.

The choice of reaction conditions is critical to the degree of conversion. If the reaction region is configured as a vessel located upstream of the dissociation reactor, preference is given, according to the present invention, to temperatures of from 50 to 250° C. in the reaction region. Particular preference is given to from 60 to 200° C.

Furthermore, preference is given to setting a residence time of 0.1-36 h, more preferably 1-12 h. Finally, a pressure of 0.1-10 bar, preferably 1-5 bar, is maintained.

If the reaction region is integrated into the rectification column, a temperature range of 150-250° C., in particular 180-240° C., is preferred. In this case, the pressure is preferably 1-200 mbar, in particular 10-100 mbar. The residence time is 0.1-20 min, preferably 0.5-5 min.

The allophanate formation can, if appropriate, be carried out in the presence of one or more catalysts. The catalysts used for allophanate formation correspond to the catalysts used in processes for the preparation of the corresponding monomeric polyurethanes and/or for their thermal dissociation. These are, in particular, inorganic or organic metal compounds (alkoxides, acetylacetonates, carboxylates, halides and pseudohalides) of elements of groups IIIa, IVa, Ib, IIb, IVb, VIb, VIIb, VIIIb (in particular Al, Sn, Cu, Zn, Ti, Zr, Mo, Mn, Fe, Co, Ni compounds).

In the following, the invention is described in more detail with reference to the figures:

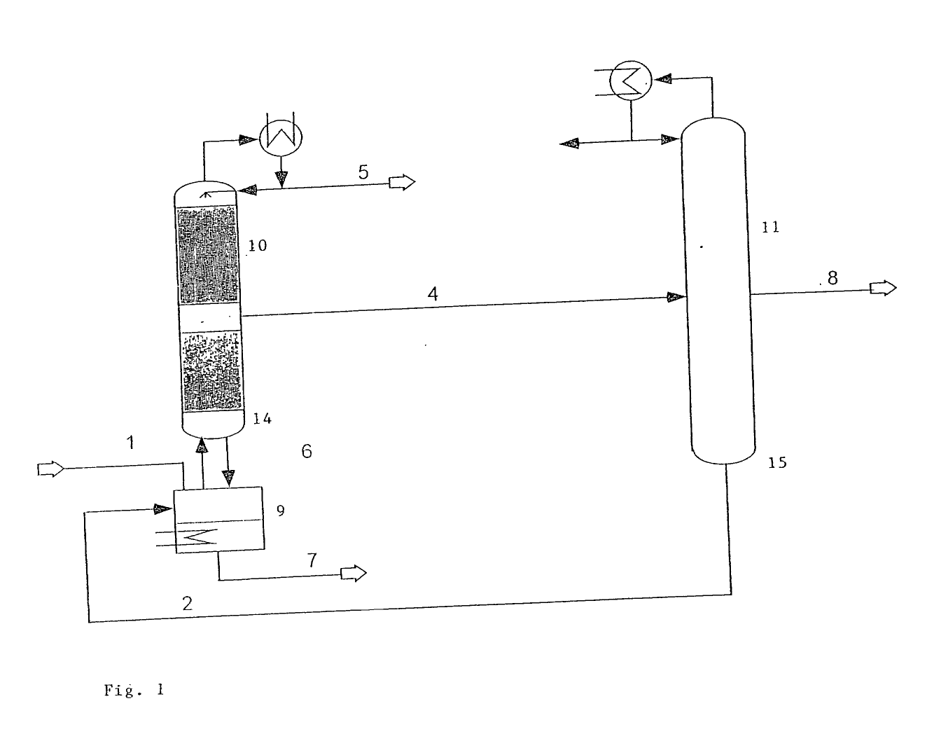

FIG. 1 shows a plant according to the prior art.

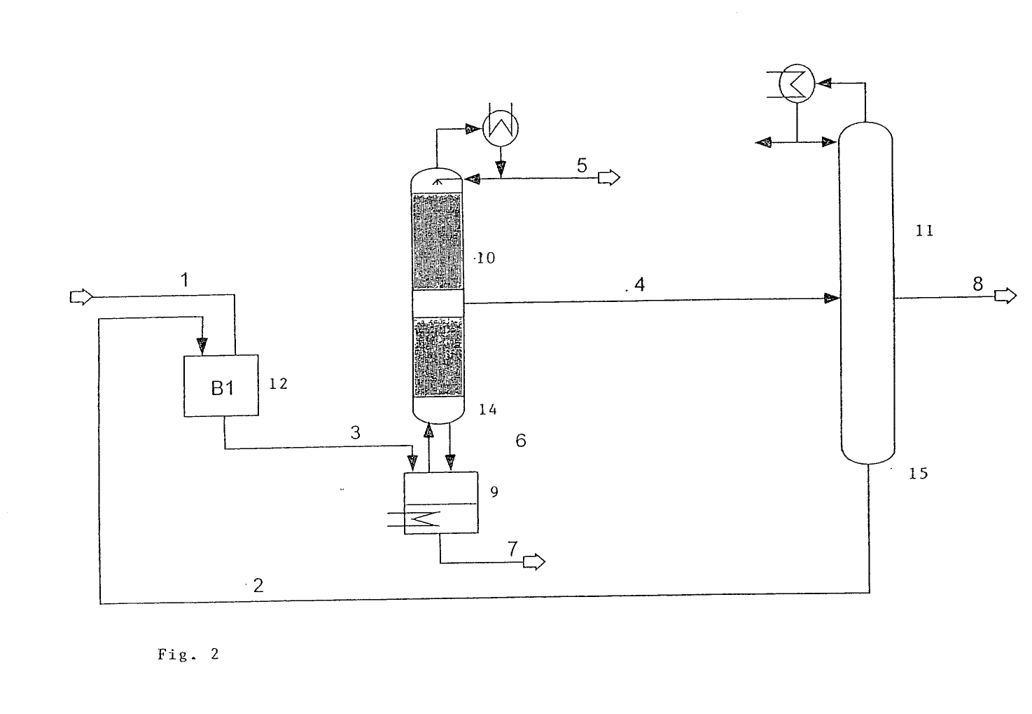

FIG. 2 shows the variant according to the present invention with a reservoir.

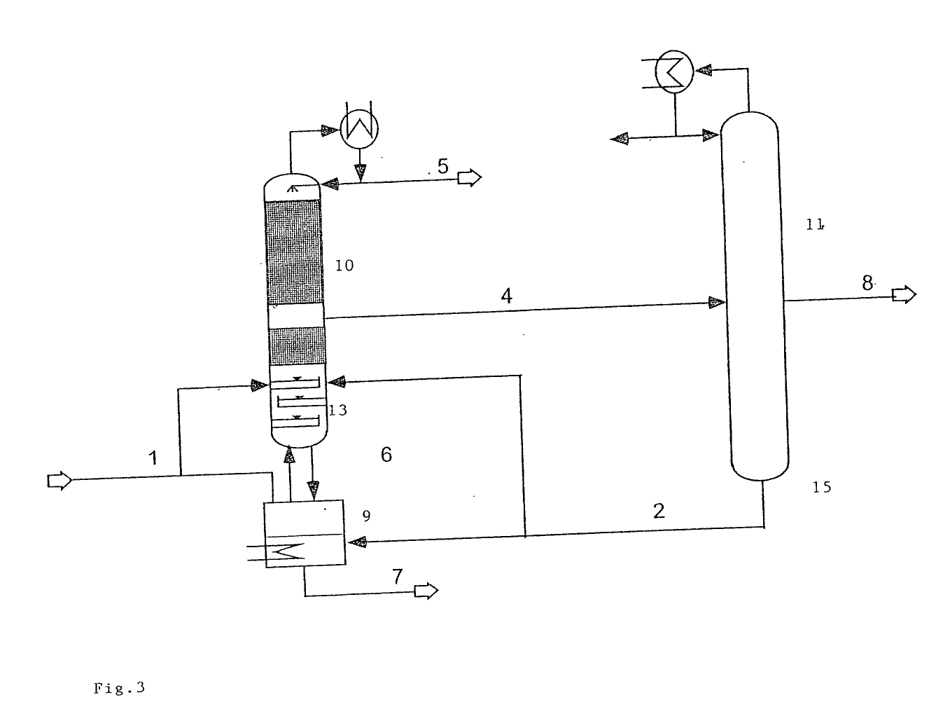

FIG. 3 shows the variant according to the present invention with specific internals in the rectification column.

FIG. 1 shows a plant according to the prior art. Here, monomeric polyurethane is fed via stream 1 into a dissociation reactor 9. In this dissociation reactor 9, the monomeric polyurethanes are dissociated while the volatile dissociation products are distilled off at the same time. A rectification column 10 is located downstream of the dissociation reactor. The polyisocyanate obtained is discharged via stream 4. The undissociated proportion of the reaction mixture and the high-boiling by-products formed constitute the bottom fraction 15. This is recirculated via stream 6 to the dissociation reactor.

The polyisocyanate conveyed via stream 4 to the distillation column 11 is subjected to a final distillation and discharged via stream 8. The bottom fraction obtained comprises relatively large amounts of partially dissociated isocyanate containing urethane groups and oligomers derived therefrom. This bottom fraction 15 is recirculated via stream 2 to the dissociation reactor 9.

The plant shown in FIG. 2 has essentially the same structure as that in FIG. 1. The only difference is that the monomers supplied via stream 1 are not fed directly into the dissociation reactor 9. Instead, the monomers are firstly introduced into the reservoir 12. This vessel, which is separate from the dissociation reactor 9, can be heated.

In addition, the bottom fraction 15 from the distillation column 11 is fed via stream 2 into the reservoir. Thus, the bottom fraction which is only partly dissociated and comprises isocyanate containing urethane groups is combined, either wholly or at least partly, in the reservoir 12 with the monomeric polyurethane used for the dissociation. A chemical reaction of the monomeric polyurethane fed in via stream 1 therefore occurs in the reservoir 12, resulting in partial or even complete conversion into allophanates. As has already been indicated in the general part of the description above, temperatures of from 12 to 250° C. and pressures of from 0.1 to 10 bar are set in the reservoir 12. The residence time is normally from 0.1 to 36 hours, before the reaction products are conveyed via stream 3 to the dissociation reactor 9.

Finally, FIG. 3 shows, as a further variant of the invention, a plant in which the reaction region 13 is integrated into the rectification column 10 located downstream of the dissociation reactor 9. Accordingly, the reaction region 13 is provided with internals in which the formation of the allophanates occurs. In the variant shown, the monomeric polyurethanes can be fed directly into the reaction region 13 or can be introduced into the dissociation reactor 9. Furthermore, it can be seen from FIG. 3 that the bottom fraction 15 can be conveyed via stream 2 either directly into the dissociation reactor or into the reaction region 13.

The invention is illustrated below by means of examples.

### EXAMPLE 1

### Comparative Example

Hexamethylene-1,6-dibutylurethane which was free of O-butyl carbamate and contained 0.15 mol % of dibutyltin dilaurate was fed continuously in the molten state via a metering device into a steam-heated vaporization reactor having a reaction volume of 2.5 l for the homogeneously catalyzed thermal dissociation. The dissociation to a conversion of about 55% based on the 3.81 kg/h of hexamethylene-1,6-dibutylurethane used occurred at 30 mbar with vigorous boiling of the reaction mixture. The vapors went into a rectification column where they were fractionated and 1.1 kg/h of liquid butanol from the dissociation were taken off at the top. A crude diisocyanate having a purity of about 95% by weight was obtained at the side offtake. Undissociated diurethane and 6-isocyanatohexyl-1-butylurethane were returned to the vaporization reactor from which a liquid stream comprising high-boiling by-products was taken off continuously. The hexamethylene 1,6-diisocyanate obtained in this way was subjected to a final distillation in which 1.115 kg/h of hexamethylene 1,6-diisocyanate having a purity of >99% were obtained at the side offtake of a column operated at 30 mbar. The bottoms from the final distillation, which were composed predominantly of 6-isocyanatohexyl-1-butylurethane and its higher molecular weight oligomers, were recirculated directly to the vaporization reactor or into the downstream rectification column.

### EXAMPLE 2

### According to the Present Invention

Molten hexamethylene-1,6-dibutylurethane which was free of O-butyl carbamate and contained 0.15 mol % of dibutyltin dilaurate together with the molten bottoms obtained in the final distillation of the hexamethylene 1,6-diisocyanate were fed continuously into a heated vaporization reactor which had a reaction volume of 10 l and an internal temperature of about 130° C. The mixture obtained in this way was fed continuously via a metering device into a steam-heated vaporization reactor having a reaction volume of 2.5 l for the homogeneously catalyzed thermal dissociation. The dissociation to a conversion of about 60% based on the 3.81 kg/h of hexamethylene-1,6-dibutylurethane used occurred at 30 mbar with vigorous boiling of the reaction mixture. The vapors went into a rectification column where they were fractionated and 1.2 kg/h of liquid butanol from the dissociation were taken off at the top. A crude diisocyanate having a purity of about 98% by weight was obtained at the side offtake. Undissociated diurethane and 6-isocyanatohexyl-1-butylurethane were returned to the vaporization reactor from which a liquid stream comprising high-boiling by-products was taken off continuously. The hexamethylene 1,6-diisocyanate obtained in this way was subjected to a final distillation in which 1.21 kg/h of hexamethylene 1,6-diisocyanate having a purity of >99% were obtained at the side offtake of a column operated at 30 mbar. The bottoms from the final distillation, which were composed predominantly of 6-isocyanatohexyl-1-butylurethane and its higher molecular weight oligomers, were recirculated directly to the abovementioned heated reaction region.

### EXAMPLE 3

### According to the Present Invention

Molten hexamethylene-1,6-dibutylurethane which was free of O-butyl carbamate and contained 0.15 mol % of dibutyltin dilaurate together with the molten bottoms obtained in the final distillation of the hexamethylene 1,6-diisocyanate were fed continuously into a heated reservoir whose contents were continuously circulated and which had a reaction volume of 10 l and an internal temperature of 184° C. The mixture obtained in this way was fed continuously via a metering device into a steam-heated vaporization reactor having a reaction volume of 2.5 l for the homogeneously catalyzed thermal dissociation. The dissociation to a conversion of about 62% based on the 4.42 kg/h of hexamethylene-1,6-dibutylurethane used occurred at 30 mbar with vigorous boiling of the reaction mixture. The vapors went into a rectification column where they were fractionated and 1.47 kg/h of liquid butanol from the dissociation were taken off at the top. A crude diisocyanate having a purity of about 97% by weight was obtained at the side offtake. Undissociated diurethane and 6-isocyanatohexyl-1-butylurethane were returned to the vaporization reactor from which a liquid stream comprising high-boiling by-products was taken off continuously. The hexamethylene 1,6-diisocyanate obtained in this way was subjected to a final distillation in which 1.44 kg/h of hexamethylene 1,6-diisocyanate having a purity of >99% were obtained at the side offtake of a column operated at 30 mbar. The bottoms from the final distillation, which were composed predominantly of 6-isocyanatohexyl-1-butylurethane and its higher molecular weight oligomers, were continuously recirculated directly to the abovementioned heated reservoir.

TABLE

| | | Example 2 | Example 3 |
|---|---|---|---|
| | Example 1 | according to | according to |
| | Comparative | the present | the present |
| | example | invention | invention |
| Feed rate (kg/h) | 3.81 | 3.81 | 4.42 |
| of hexamethylene- | | | |
| 1,6-dibutyl- | | | |
| urethane | | | |
| Concentration (% | 95 | 98 | 97 |
| by mass) of | | | |
| hexamethylene 1,6- | | | |
| diisocyanate in | | | |
| the fraction taken | | | |
| off at the side | | | |
| offtake of the | | | |
| rectification | | | |
| column | | | |
| Recirculated | 0.10 | 0.10 | 0.12 |
| bottoms stream | | | |
| (kg/h) from final | | | |
| distillation | | | |
| Temperature of | No preceding | 130 | 184 |
| reservoir (° C.) for | allophanate | | |
| allophanate | formation | | |
| formation | | | |
| Product stream | 1.115 | 1.21 | 1.44 |
| (kg/h) of | | | |
| hexamethylene 1,6- | | | |
| diisocyanate | | | |
| Conversion of | 55 | 60 | 62 |
| hexamethylene-1,6- | | | |
| dibutylurethane | | | |
| (mol %) | | | |

We claim:

1. A process for preparing organic polyisocyanates in which polyurethanes are thermally dissociated in a dissociation reactor, a distillation is subsequently carried out and the bottom fraction obtained here is recirculated, wherein the recirculated bottom fraction is firstly fed at least partly into a reaction region and subsequently into the dissociation reactor.

2. A process as claimed in claim 1, wherein additional monomer polyurethane is introduced into the reaction region.

3. A process as claimed in claim 1 or 2, wherein catalysts are introduced into the reaction region.

4. A process as claimed in claim 3, wherein the catalysts are inorganic or organic metal compounds of elements of groups IIIa, IVa, Ib, IIb, IVb, VIb, VIIb, VIIIb.

5. A process as claimed in claim 2, wherein part of the monomeric polyurethane is introduced into the dissociation reactor and part of it is introduced into the reaction region.

6. A process as claimed in any of claims 1 to 5, wherein the recirculated bottom fraction and the monomeric polyurethane are fed continuously into the reaction region.

7. A process as claimed in any of claims 1 to 6, wherein the residence time of the bottom fraction and of the monomeric polyurethane and the temperature in the reaction region are set so that at least partial conversion into allophanates occurs.

8. A process as claimed in claim 7, wherein the isocyanates from the bottom fraction react completely with the monomeric polyurethane in the reaction region to form allophanates.

9. A process as claimed in any of claims 1 to 8, wherein the bottom fraction is conveyed via a reaction region which is configured as a separate, heatable vessel.

10. A process as claimed in claim 9, wherein the temperature in the reaction region is set to from 50 to 250° C.

11. A process as claimed in claim 9 or 10, wherein the temperature in the reaction region is set to from 60 to 200° C.

12. A process as claimed in any of claims 9 to 11, wherein the residence time in the reaction region is 0.1-36 h.

13. A process as claimed in any of claims 9 to 12, wherein the residence time in the reaction region is 1-12 h.

14. A process as claimed in any of claims 9 to 13, wherein the pressure is from 0.1 to 10 bar.

15. A process as claimed in any of claims 9 to 14, wherein the pressure is from 1 to 5 bar.

16. A process as claimed in any of claims 1 to 7, wherein the bottom fraction is conveyed via a reaction region which is integrated into the reaction column located downstream of the dissociation reactor.

17. A process as claimed in claim 16, wherein the temperature is from 150 to 250° C.

18. A process as claimed in claim 16 or 17, wherein the pressure is from 1 to 200 mbar.

19. A process as claimed in any of claims 16 to 18, wherein the residence time is from 0.1 to 20 min.

20. An apparatus comprising at least one dissociation reactor and at least one rectification column for preparing organic polyisocyanates by thermal dissociation of polyurethane and subsequent distillation, wherein a heatable reaction region is located in at least one feed line to the dissociation reactor.

21. An apparatus as claimed in claim 20, wherein the reaction region is located in the return line from the rectification column to the dissociation reactor.

22. An apparatus as claimed in claim 20, wherein the reaction region has at least one feed line for monomeric polyurethane.

23. An apparatus as claimed in any of claims 20 to 22, wherein the reaction region is configured as a separate, heatable vessel.

24. An apparatus as claimed in any of claims 20 to 23, wherein the reaction region is integrated into the rectification column located downstream of the dissociation reactor.

25. The use of an apparatus as claimed in any of claims 20 to 24 for preparing polyisocyanates.
